(19) United States
(12) Patent Application Publication
(10) Pub. No.: US 2009/0152260 A1
(43) Pub. Date: Jun. 18, 2009

(54) INDUCTION HEATING DEVICE

(75) Inventors: Tomoya Fujinami, Hyogo (JP); Masaharu Ohashi, Hyogo (JP); Takeshi Kitaizumi, Osaka (JP); Izuo Hirota, Hyogo (JP); Hiroshi Tominaga, Hyogo (JP); Kenji Watanabe, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/162,771

(22) PCT Filed: Jan. 31, 2007
(86) PCT No.: PCT/JP2007/051543

§ 371 Date: Jul. 30, 2008

(30) Foreign Application Priority Data
Feb. 8, 2006 (JP) 2006-030775

(51) Int. Cl. H05B 6/02

(52) U.S. Cl. 219/600

(57) ABSTRACT

An induction heating device includes a top plate arranged to have an object placed thereon, a heating coil receiving a high-frequency current to inductively heat the object, an infrared ray sensor for outputting a signal in accordance with energy of received infrared ray, a temperature detector for detecting a temperature of the object based on the signal output from the infrared ray sensor, a heating controller for controlling the high-frequency current supplied to the heating coil based on the detected temperature, and a failure determining unit for determining whether the infrared ray sensor has a failure or not. This induction heating device can detect the failure of the infrared ray sensor, and thus stops or suppresses the heating upon detecting the failure of the infrared ray sensor.

### TECHNICAL FIELD

The present invention relates to an induction heating device including an infrared ray sensor for sensing the temperature of an object to be heated.

### BACKGROUND ART

FIG. 7 is a schematic view of conventional induction heating device 5001 disclosed in Patent Publication 1. Induction heating device 5001 includes top plate 2 having object 1, such as a pot, to be heated placed thereon, heating coil 3 provided under top plate 2, infrared ray sensor 4 facing a bottom of object 1, temperature detector 5 that converts a light energy received by infrared ray sensor 4 to a temperature, and heating controller 6 allows a high-frequency current to flow in heating coil 3 as to inductively heat object 1.

When the heating starts, the high-frequency current from heating controller 6 allows heating coil 3 to generate a high-frequency magnetic field. This high-frequency magnetic field heats object 1 and raises a temperature of object 1. Infrared ray sensor 4 receives infrared ray emitted from the bottom of object 1 to output a signal in accordance with the energy of the infrared ray. Temperature detector 5 converts the signal to a temperature. Heating controller 6 controls, based on the temperature, the current flowing in heating coil 3 to control the heating of the object.

Conventional induction heating device 5001 does not detect a failure of infrared ray sensor 4, and thus, cannot detect the temperature properly when infrared ray sensor 4 has a failure.

Patent Document 1: JP2003-109736A

### SUMMARY OF THE INVENTION

An induction heating device includes a top plate arranged to have an object placed thereon, a heating coil receiving a high-frequency current to inductively heat the object, an infrared ray sensor for outputting a signal in accordance with energy of received infrared ray, a temperature detector for detecting a temperature of the object based on the signal output from the infrared ray sensor, a heating controller for controlling the high-frequency current supplied to the heating coil based on the detected temperature, and a failure determining unit for determining whether the infrared ray sensor has a failure or not.

This induction heating device can detect the failure of the infrared ray sensor, and thus stops or suppresses the heating upon detecting the failure of the infrared ray sensor.

### BRIEF DESCRIPTION OF THE DRAWINGS

FIG. 1 is a schematic view of an induction heating device according to Exemplary Embodiment 1 of the present invention.

FIG. 2 shows a distribution of light energy to a wavelength of the induction heating device according to Embodiment 1.

FIG. 3 is a schematic view of an induction heating device according to Exemplary Embodiment 2 of the invention.

FIG. 4 is a schematic view of an induction heating device according to Exemplary Embodiment 3 of the invention.

FIG. 5 is a schematic view of the induction heating device according to Embodiment 3 of the invention.

FIG. 6 is a schematic view of the induction heating device according to Embodiment 3 of the invention.

FIG. 7 is a schematic view of a conventional induction heating device.

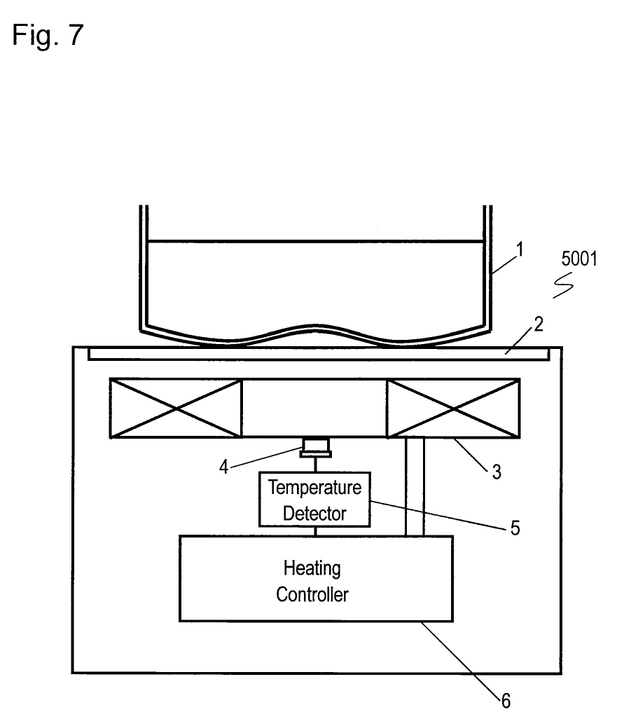

### REFERENCE NUMERALS

1 Object
2 Top Plate
3 Heating Coil
4 Infrared Ray Sensor
4A Sensing Element
5 Temperature Detector
7 Light Emitter
8 Failure Determining Unit
9 Notifying Unit
10 Object Detector
11 Light Blocker
106 Heating Controller

### DETAILED DESCRIPTION OF THE PREFERRED EMBODIMENTS

### Exemplary Embodiment 1

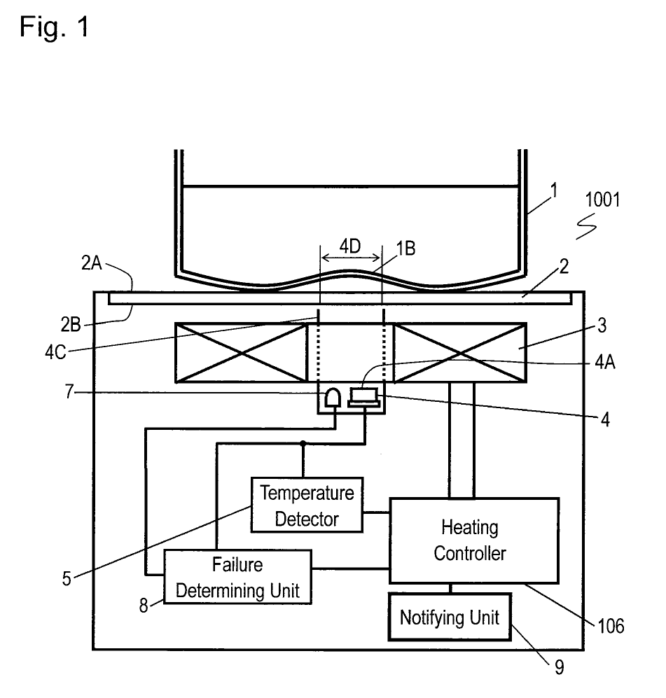

FIG. 1 is a schematic view of induction heating device 1001 according to Exemplary Embodiment 1 of the present invention. Top plate 2 has upper surface 2A and lower surface 2B opposite to upper surface 2A. Upper surface 2A is arranged to have object 1, such as a pot, to be heated placed thereon. Heating coil 3 is located under top plate 2. Infrared ray sensor 4 faces bottom 1B of object 1 and has sensing element 4A receiving light. Temperature detector 5 detects the temperature of object 1 based on light energy received by infrared ray sensor 4. Heating controller 106 allows a high-frequency current to flow in heating coil 3 as to inductively heat object 1. Light emitter 7 generates light reaching sensing element 4A of infrared ray sensor 4. Light emitter 7 and infrared ray sensor 4 are provided in light guiding tube 4C.

An operation of induction heating device 1001 will be described below.

First, when a user sends an instruction to induction heating device 1001 to start a heating operation via an operation unit connected to heating controller 106, heating controller 106 supplies a high-frequency current to heating coil 3. Object 1 is placed on upper surface 2A of top plate 2 above heating coil 3. Object 1 is magnetically coupled to heating coil 3. Upon having the high-frequency current flowing therein, heating coil 3 generates a high-frequency magnetic field. This magnetic field generates eddy currents flowing in object 1 due to electromagnetic induction in object 1, thereby heating object 1 by Joule heating due to the eddy currents.

Infrared ray sensor 4 receives infrared ray emitted from object 1 via top plate 2, and sends a signal in accordance with the energy of the received infrared ray to temperature detector 5. Temperature detector 5 detects the temperature of object 1 based on the signal and sends a signal in accordance with the detected temperature to heating controller 106.

Based on the signal sent from temperature detector 5, heating controller 106 controls a power supplied to heating coil 3 so that object 1 has a temperature determined by the user. If a heating operation starts in a fry-cooking mode, for example, heating controller 106 controls the power supplied to heating coil 3 to maintain the temperature of object 1 at a predetermined temperature. When the temperature of object 1 is an excessively high temperature, heating controller 106 reduces or stops the power in order to prevent a failure such as oil firing. Heating controller 106 may be provided unitarily with temperature detector 5. Controller 106 may be implemented by, for example, a digital signal processor (DSP) or a microcomputer, however, is not limited to them. Heating controller 106 may be another element, such as a custom IC, having a predetermined function.

Object 1 is magnetically coupled to heating coil 3 and is generally made of magnetic material. Object 1 may be made of nonmagnetic and low-resistant metal, such as copper or aluminum and can be heated by induction heating device 1001. When object 1 is too small to cover heating coil 3 or when a large gap is provided between top plate 2 and object 1, induction heating device 1001 is often prevented from heating object 1.

Top plate 2 constitutes the appearance of induction heating device 1001 and has upper surface 2A arranged to have object 1 placed thereon. Top plate 2 is made of a flat plate made of, for example, heat resistant, strengthened glass. Thus, upper surface 2A is flat and can be cleaned easily.

Infrared ray sensor 4 receives the infrared ray emitted from object 1 and detects a temperature of object 1 to output a signal according to the detected temperature. Thus, Infrared ray sensor 4 can detect the temperature of object 1 following the temperature change of object 1 regardless of an area at which object 1 contacts top plate 2 and the heat capacity of top plate 2. A temperature sensor of contact type, such as a thermocouple or a thermistor, is mounted to contact the lower surface of the top plate. The upper surface of the top plate 2 is heated by the heat conduction and the radiation heat in the area at which the object 1 contacts the top plate 2. Then, the heat in the upper surface conducts to the lower surface of the top plate, thus allowing this temperature sensor of contacting type to measure the temperature of the lower surface. Thus, the temperature sensor of contact type measures the temperature of object 1 via the top plate 2 while being influenced by the area at which object 1 contacts top plate 2 and the heat capacity of the top plate, hence being prevented from quickly following the temperature change of object 1.

When object 1 having no food therein is heated, the temperature of object 1 rapidly rises. Induction heating device 1001 includes a safety device prevent the temperature of object 1 from rising to a temperature higher than a firing temperature of oil. Since the temperature sensor of contact type does not quickly follow the temperature change of the object, the induction heating device including this sensor reduces a heating rate with a large margin to the oil firing temperature to prevent the oil from firing. However, reducing the heating rate, the heating device cannot pre-heat the object 1, such as a frying pan, quickly. Infrared ray sensor 4 can quickly follow the temperature change of object 1, and increases the heating rate, accordingly allowing object 1 to be pre-heated quickly.

Temperature detector 5 detects the temperature of object 1 based on the signal output from infrared ray sensor 4. The energy of the light received by infrared ray sensor 4 is converted to a physical quantity, such as a voltage, a current, or a frequency, determined according to the energy and is output as a signal having the physical quantity. Temperature detector 5 detects the physical quantity based on the signal, and detects the temperature based on the physical quantity. The detected temperature is sent to heating controller 106. Induction heating device 1001 is controlled in accordance with the temperature.

As described above, heating controller 106 controls the power supplied to heating coil 3 based on the signal output from infrared ray sensor 4. When infrared ray sensor 4 fails and cannot appropriately output the signal in accordance with the temperature of object 1, infrared ray sensor 4 may not detect that the temperature of object 1 rises to an excessively high temperature. In this case, heating controller 106 may continuously heat object 1 excessively, consequently damaging object 1.

In order to avoid the above failure, induction heating device 1001 includes light emitter 7 that generates light reaching sensing element 4A of infrared ray sensor 4. Light emitter 7 includes an infrared ray light-emitting diode (LED) or a light-emitting element, such as an electric lamp, generating light within a wavelength range that can be detected by infrared ray sensor 4.

Light emitter 7 is located to allow light emitted from light emitter 7 to reach sensing element 4A of infrared ray sensor 4. When light emitter 7 generates light, the energy of the light received by infrared ray sensor 4 increases, and accordingly, changes the signal output from infrared ray sensor 4. Failure determining unit 8 detects this change to determine whether infrared ray sensor 4 has a failure or not, that is, whether sensor 7 properly outputs the signal according to the temperature of object 1 or not, and sends the determination result to heating controller 106. When failure determining unit 8 determines that infrared ray sensor 4 has the failure, heating controller 106 does not supply the high-frequency current to heating coil 3 or reduces the high-frequency current. This operation prevents the temperature of object 1 from excessively rising when object 1 is continuously heated while leaving infrared ray sensor 4 having the failure.

A method of determining the failure of infrared ray sensor 4 at determining unit 8 will be described below.

Failure determining unit 8 is connected to infrared ray sensor 4, light emitter 7, and heating controller 6. First, light emitter 7 is activated to generate light. Upon receiving the light generated from light emitter 7, infrared ray sensor 4 outputs a signal in accordance with the light. Failure determining unit 8 calculates the energy of the light received by infrared ray sensor 4 based on the signal. If the energy is less than a predetermined threshold, failure determining unit 8 determines that infrared ray sensor 4 has a failure. If the energy is greater than the predetermined threshold, failure determining unit 8 determines that infrared ray sensor 4 has no failure and is normal. The determination result is sent to heating controller 6. If failure determining unit 8 determines that infrared ray sensor 4 has a failure, heating controller 106 does not supply the high-frequency current to heating coil 3 or reduces the high-frequency current. This can operation prevents the temperature of object 1 from excessively rising due to the heating while infrared ray sensor 4 has a failure.

The threshold for determining the failure is determined based on the energy of the light sent from light emitter 7 to infrared ray sensor 4 having no failure. The intensity of the light emitted from light emitter 7 may decrease due to a change over time. If the intensity of the light emitted from light emitter 7 decreases, the threshold is determined for the energy of the light received by infrared ray sensor 4.

When failure determining unit 8 determines that infrared ray sensor 4 has the failure, heating controller 6 stops the heating of object 1 or suppresses the heating of object 1. Since induction heating device 1001 heats object 1 with a high-frequency magnetic field invisible to naked eyes, the user can hardly recognize the stopping or suppressing of the heating of object 1. Induction heating device 1001 includes notifying unit 9 that notifies the user of the failure of infrared ray sensor 4 when failure determining unit 8 determines that infrared ray sensor 4 has a failure.

Notifying unit 9 can notify the user that object 1 cannot be heated as desired since infrared ray sensor 4 has a failure, thereby prompting the user to fix infrared ray sensor 4.

Notifying unit 9 notifies the user of the failure of infrared ray sensor 4 visually or auditorily. However, the failure may be notified by another means sensuous to the user. If notifying unit 9 notifies the failure visually, notifying unit 9 includes a lamp, such as a light-emitting diode, or a display device, such as a liquid crystal display. If notifying unit 9 notifies the failure auditorily, notifying unit 9 includes a buzzer, a melody, or an audio assist.

Failure determining unit 8 may set the timing at which failure determining unit 8 determines the failure of infrared ray sensor 4. Alternatively, heating controller 6 connected to failure determining unit 8 may set the timing.

Heating controller 6 may set the timing at which heating controller 6 determines the failure, and thereby, determines the failure in accordance with a heating sequence. For example, before the starting of the heating of object 1, that is, before to the supplying of the high-frequency current to heating coil 3, failure determining unit 8 can determine at least once whether infrared ray sensor 4 has a failure or not. This operation prevents object 1 from being heated when failure determining unit 8 determines that infrared ray sensor 4 has the failure.

Infrared ray sensor 4 is located in light guiding tube 4C. Light guiding tube 4C forms detectable region 4D of infrared ray sensor 4. Light passes through detectable region reaches sensing element 4A. Light from the region other than detectable region 4D does not reach infrared ray sensor 4. Infrared ray sensor 4 may receive the light around induction heating device 1001 in addition to the infrared ray emitted from object 1 having a high temperature. When the light around induction heating device 1001 reaches sensing element 4A of infrared ray sensor 4 and is mixed into the infrared ray from object 1, temperature detector 5 cannot detect the temperature of object 1 accurately. In order to prevent this, the user places object 1 on upper surface 2A of top plate 2 so as to entirely cover detectable region 4D of infrared ray sensor 4 with object 1.

Object 1 placed in the above manner prevents the light around induction heating device 1001 from reaching sensing element 4A of infrared ray sensor 4, thus, allowing infrared ray sensor 4 to receive only the light from object 1 and the light from light emitter 7.

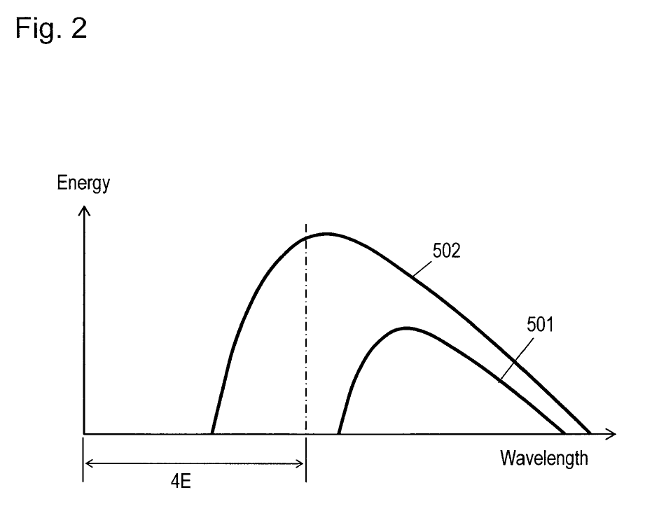

FIG. 2 illustrates the distribution of the energy of the light that is emitted from object 1 and that is received by infrared ray sensor 4. In FIG. 2, the horizontal axis represents the wavelength of the light, and the vertical axis represents the energy of the light. Infrared ray sensor 4 outputs a signal in accordance with the energy of the light (infrared ray) having a wavelength within detectable wavelength range 4E. When infrared ray sensor 4 receives light having a wavelength outside detectable wavelength range 4E, infrared ray sensor 4 does not generate a signal. When object 1 is heated to have temperature T1, object 1 generates the light having the distribution shown as curve 501. Even if infrared ray sensor 4 receives this light, infrared ray sensor 4 generates no signal. When object 1 is further heated to raise the temperature to temperature T2 (T2>T1), object 1 generates the light having the distribution shown as curve 502. When infrared ray sensor 4 receives this light, infrared ray sensor 4 generates a signal in accordance with the energy of the light. That is, when object 1 has a high temperature, object 1 generates infrared ray having a wavelength within detectable wavelength range 4E of infrared ray sensor 4. The higher temperature object 1 has, the higher the energy of the infrared ray generated from object 1 is. When the light generated by light emitter 7 in order to determine the failure of infrared ray sensor 4 has the energy smaller than the energy of the infrared ray emitted from object 1, the light from light emitter 7 is buried in the light from object 1.

While infrared ray sensor 4 does not receive infrared ray from object 1 or while infrared ray sensor 4 receives the light having the energy having a predetermined level smaller than the energy of the light from light emitter 7, heating controller 106 or failure determining unit 8 allows light emitter 7 to generate light to determine whether infrared ray sensor 4 has a failure or not. Thereby, failure determining unit 8 can accurately determine whether infrared ray sensor 4 has the failure or not.

### Exemplary Embodiment 2

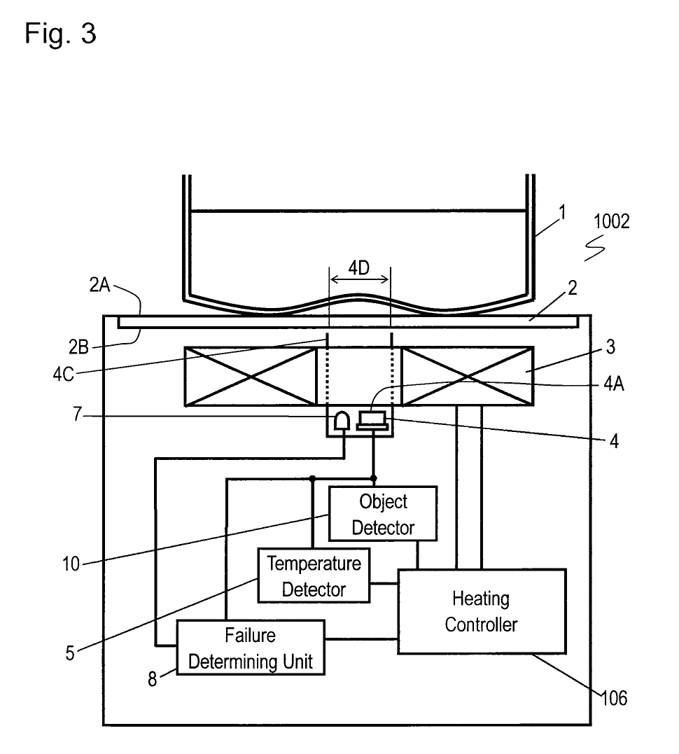

FIG. 3 is a schematic view of induction heating device 1002 according to Exemplary Embodiment 2 of the present invention. In FIG. 3, components identical to those of induction heating device 1001 shown in FIG. 1 are denoted by the same reference numerals, and their description will be omitted. Induction heating device 1002 further includes object detector 10 connected to infrared ray sensor 4 and heating controller 6 of induction heating device 1001 shown in FIG. 1.

When object 1 does not cover detectable region 4D of infrared ray sensor 4, the light around object 1 reaches sensing element 4A of infrared ray sensor 4. In this case, the temperature detected by temperature detector 5 includes a lot of error, accordingly preventing temperature detector 5 from accurately detecting the temperature of object 1. Thus, heating controller 6 for controlling a high-frequency current supplied to heating coil 3 based on the detected temperature cannot control the high-frequency current accurately. Specifically, the light around object 1 received by infrared ray sensor 4 raises the temperature of object 1 detected by the temperature detector 5 to a temperature higher than an actual temperature of object 1. This may cause heating controller 106 to heat object 1 so that the temperature of object 1 is lower than a predetermined temperature. This may cause, for example, food that originally be cooked at 200° C. to be cooked at about 150° C. This also may prevent object 1, such as a frying pan, from being sufficiently pre-heated when a function preventing an empty pan from being heated is activated during the pre-heating. Thus, sensing element 4A of infrared ray sensor 4 is required not to receive light other than the infrared ray from object 1.

Based on the signal output from infrared ray sensor 4, object detector 10 determines whether or not object 1 is placed on top plate 2 to cover detectable region 4D of infrared ray sensor 4. When object detector 10 determines that detectable region 4D of infrared ray sensor 4 is covered by object 1, heating controller 106 supplies a high-frequency current to heating coil 3 to heat object 1. When object detector 10 determines that object 1 is not placed on top plate 2, that is, detectable region 4D of infrared ray sensor 4 is not covered by object 1, heating controller 106 does not supply the high-frequency current to heating coil 3 to prevent object 1 from being heated.

When detectable region 4D of infrared ray sensor 4 is covered by object 1, the light around object 1 does not reach sensing element 4A of infrared ray sensor 4. Under this situation, when light emitter 7 generates light in order to determine whether infrared ray sensor 4 has a failure or not, infrared ray sensor 4 receives only the light from light emitter 7, and thus, determine the failure of infrared ray sensor 4 accurately Thus, when object detector 10 determines that detectable region 4D of infrared ray sensor 4 is covered by object 1, failure determining unit 8 determines whether infrared ray sensor 4 has a failure or not. Specifically, failure determining unit 8 allows light emitter 7 to generate light, and then, infrared ray sensor 4 receives the light generated by light emitter 7 to output a signal in accordance with the received light. Based on the signal, failure determining unit 8 calculates the energy of the light received by infrared ray sensor 4. When the energy is smaller than a predetermined threshold, failure determining unit 8 determines that infrared ray sensor 4 has a failure. When the energy is larger than the predetermined threshold, failure determining unit 8 determines that infrared ray sensor 4 has no failure. When object detector 10 determines that detectable region 4D of infrared ray sensor 4 is not covered by object 1, failure determining unit 8 does not determine whether infrared ray sensor 4 has a failure or not.

When object detector 10 determines that detectable region 4D of infrared ray sensor 4 is not covered by object 1, light emitter 7 may generate visible light. This visible light can allow the user to recognize that detectable region 4D is not covered by object 1. Thus, the user can be prompted to appropriately place object 1 again.

Object detector 10 may be implemented at least partially by temperature detector 5, heating controller 6, or failure determining unit 8. The above functions may be implemented by, for example, a digital signal processor (DSP) or a microcomputer. The above functions also may be implemented by an element, such as a custom IC, having a predetermined function.

### Exemplary Embodiment 3

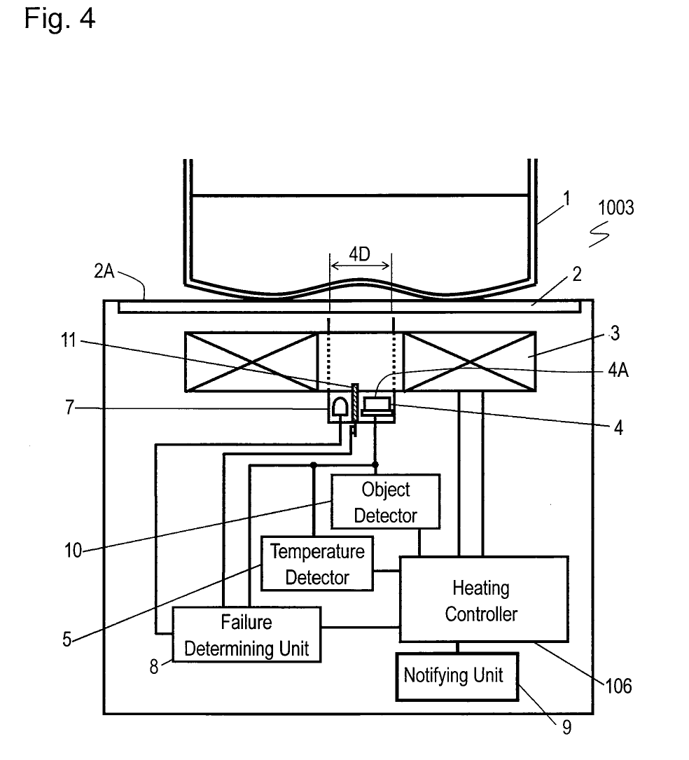

FIG. 4 is a schematic view of induction heating device 1003 according to Exemplary Embodiment 3 of the present invention. In FIG. 4, components identical to those of induction heating device 1001 shown in FIG. 1 are denoted by the same reference numerals, and their description will be omitted. Induction heating device 1003 further includes light blocker 11 in addition to induction heating device 1001 shown in FIG. 1. Light blocker 11 can block light generated by light emitter 7 to prevent the light from reaching sensing element 4A of infrared ray sensor 4 directly from light emitter 7. Thus, the light directed toward detectable region 4D reaches sensing element 4A of infrared ray sensor 4.

Light blocker 11 is provided between infrared ray sensor 4 and light emitter 7. Light blocker 7 is made of material and has a shape to prevent the light generated by light emitter 7 from reaching sensing element 4A of infrared ray sensor 4 directly from light emitter 7. Light blocker 11 can switch selectively between a mode for allowing the light generated by light emitter 7 to reach sensing element 4A of infrared ray sensor 4 directly from light emitter 7 and a mode for preventing the light generated by light emitter 7 from reaching sensing element 4A of infrared ray sensor 4 directly from light emitter 7. In FIG. 4, light blocker 11 is connected to failure determining unit 8, however, may be connected to heating controller 6, temperature detector 5, or object detector 10.

When failure determining unit 8 determines whether infrared ray sensor 4 has a failure or not, light blocker 11 allows the light generated by light emitter 7 to reach sensing element 4A of infrared ray sensor 4 directly from light emitter 7.

When light emitter 7 emits light for a purpose other than the purpose of determining the failure of infrared ray sensor 4 and when the light generated by light emitter 7 reaches sensing element 4A of infrared ray sensor 4, temperature detector 5 cannot accurately detect the temperature of object 1. In this case, light blocker 11 blocks the light generated by light emitter 7 from reaching sensing element 4A of infrared ray sensor 4 from light emitter 7. Thereby, temperature detector 5 can accurately detect the temperature of object 1, and light emitter 7 can be used for a purpose other than the purpose of determining the failure of infrared ray sensor 4.

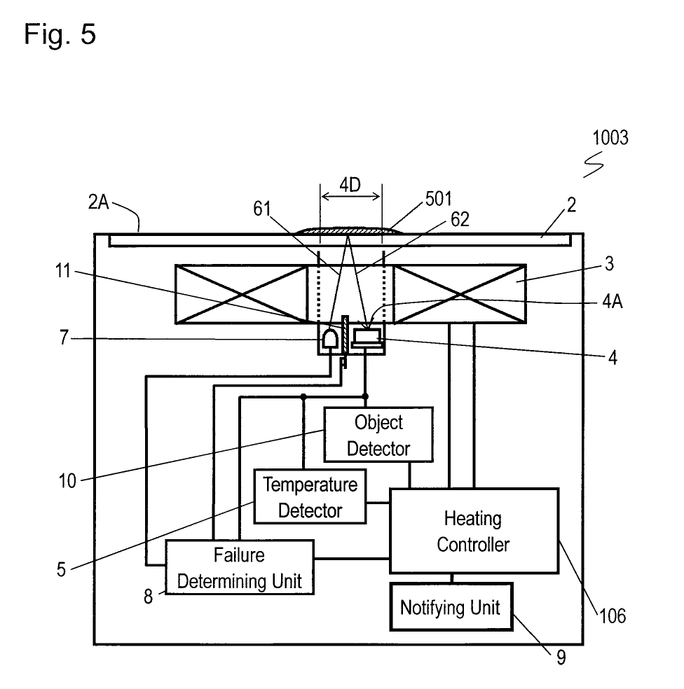

FIG. 5 is a schematic view of induction heating device 1003 according to Embodiment 3 for illustrating a function for detecting a stain. Heating controller 106 can use light blocker 11 to detect stain 501 attached onto upper surface 2A of top plate 2 particularly onto detectable region 4D of infrared ray sensor 4.

When cooking liquid or seasoning food is spilled from object 1 and is attached, as stain 501, onto detectable region 4D of upper surface 2A of top plate 2 during the use of induction heating device 1003, stain 501 attenuates infrared ray emitted from object 1. When infrared ray sensor 4 receives the attenuated infrared ray, the temperature of object 1 detected by temperature detector 5 is lower than an actual temperature of object 1. Thus, heating controller 106 increases a high-frequency current supplied to heating coil 3, raising the temperature of object 1 to a temperature higher than the temperature set by a user.

Induction heating device 1003 detects stain 501 by the following method. While not heating object 1, failure determining unit 8 or heating controller 106 allows light blocker 11 to prevent the light generated by light emitter 7 from reaching sensing element 4A of infrared ray sensor 4 directly from light emitter 7. Under this situation, heating controller 106 allows light emitter 7 to generate light 61, and light 61 is reflected by stain 501 on top plate 2. Light 62 reflected by stain 501 reaches sensing element 4A of infrared ray sensor 4 while light 61 from light emitter 7 does not reach sensing element 4A. Since light 61 from light emitter 7 is blocked by light blocker 11, infrared ray sensor 4 receives light 62 reflected by stain 501 and outputs a signal in accordance with the energy of light 62. Based on the signal, heating controller 106 determines whether detectable region 4D has stain 501 or not.

If determining that stain 501 is in detectable region 4D, heating controller 106 does not heat object 1. If heating controller 106 determines that stain 501 is in detectable region 4D, notifying unit 9 may notify the user that stain 501 is in the detectable region to prompt the user to remove stain 501. This operation prevents the temperature of object 1 from rising due to the heating of object 1 while stain 501 is attached onto top plate 2.

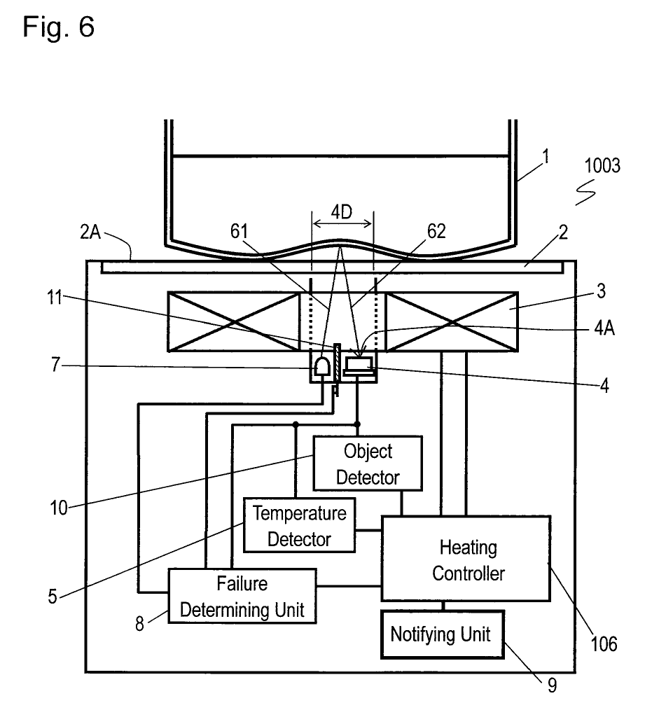

Heating controller 106 may detect stain 501 while object detector 10 determines that object 1 does not cover detectable region 4D. FIG. 6 is a schematic view of induction heating device 1003 according to Embodiment 3 for illustrating this function.

Heating controller 106 allows light blocker 11 to prevent light 61 generated by light emitter 7 from reaching sensing element 4A of infrared ray sensor 4 directly from light emitter 7, and allows light emitter 7 to generate light 61. Light 61 is reflected by stain 501, as shown in FIG. 5. Infrared ray sensor 4 receives reflected light 62, and heating controller 106 determines whether stain 501 exists or not.

When object 1 is placed on top plate 2, as shown in FIG. 6, light 61 generated by light emitter 7 transmits through top plate 2 and reaches object 1. Light 61 is reflected by object 1 to turn into light 62 reaching sensing element 4A of infrared ray sensor 4. In this case, stain 501 attached to upper surface 2A of top plate 2 cannot be detected accurately.

Thus, when object detector 10 determines that object 1 does not cover detectable region 4D of infrared ray sensor 4, heating controller 106 determines whether stain 501 exists or not. When object detector 10 determines that object 1 covers detectable region 4D of infrared ray sensor 4, heating controller 106 does not detect whether stain 501 exists or not. This operation allows heating controller 106 to detect stain 501 accurately.

According to this embodiment, failure determining unit 8 that determines whether or not the energy of the light that is generated by light emitter 7 and that is received by sensing element 4A of infrared ray sensor 4 is smaller than the threshold so as to determine whether infrared ray sensor 4 has a failure or not. Failure determining unit 8 may determine whether or not infrared ray sensor 4 has a failure, by another method.

The present invention is not limited to the above-described embodiments.

### INDUSTRIAL APPLICABILITY

An induction heating device according to the present invention can detect a failure of an infrared ray sensor to stop or suppress a heating operation when detecting the failure of the infrared ray sensor, thus being used easily.

1. An induction heating device comprising:
a top plate arranged to have an object placed thereon;
a heating coil receiving a high-frequency current to inductively heat the object;
an infrared ray sensor having a sensing element for receiving infrared ray emitted from the object via the top plate, the infrared ray sensor outputting a signal in accordance with energy of the received infrared ray;
a temperature detector for detecting a temperature of the object based on the signal output from the infrared ray sensor;
a heating controller for controlling the high-frequency current supplied to the heating coil based on the detected temperature; and
a failure determining unit for determining whether the infrared ray sensor has a failure or not.

2. The induction heating device according to claim 1, further comprising
a light emitter for generating light reaching the sensing element of the infrared ray sensor, wherein
the failure determining unit determines whether the infrared ray sensor has the failure or not by determining whether or not the light that is generated by the light emitter and that reaches the sensing element of the infrared ray sensor has an energy smaller than a threshold value, and
when the failure determining unit determines that the infrared ray sensor has the failure, the heating controller does not supply the high-frequency current to the heating coil or reduces the high-frequency current.

3. The induction heating device according to claim 2, further comprising a notifying unit for notifying the user of the failure of the infrared ray sensor when the failure determining unit determines that the infrared ray sensor has the failure.

4. The induction heating device according to claim 2, wherein the failure determining unit determines whether the infrared ray sensor has a failure or not before the heating controller supplies the high-frequency current to the heating coil.

5. The induction heating device according to claim 2, wherein, when the energy of the light received by the infrared ray sensor is smaller than a predetermined level, the failure determining unit allows the sensing element of the infrared ray sensor to receive the light generated by the light emitter so as to determine whether the infrared ray sensor has the failure or not.

6. The induction heating device according to claim 2, further comprising
an object detector for detecting, based on the light received by the infrared ray sensor, whether or not the object is placed on the top plate,
wherein, when the object detector detects that the object is placed on the top plate, the failure determining unit allows the sensing element of the infrared ray sensor to receive the light generated by the light emitter so as to determine whether the infrared ray sensor has the failure or not.

7. The induction heating device according to claim 6, wherein the light emitter generates light when the object detector detects that the object is not placed on the top plate.

8. The induction heating device according to claim 2, further comprising
a light blocker for selectively switching between a mode for preventing the light generated by the light emitter from reaching the sensing element of the infrared ray sensor from the light emitter and a mode for allowing the light generated by the light emitter to reach the sensing element of the infrared ray sensor from the light emitter,
wherein the light blocker allows the light generated by the light emitter to reach the sensing element of the infrared ray sensor from the light emitter when the failure determining unit allows the sensing element of infrared ray sensor to receive the light generated by the light emitter so as to determine whether the infrared ray sensor has the failure or not.

9. The induction heating device according to claim 8, wherein, when the light blocker prevents the light generated by the light emitter from reaching the sensing element of the infrared ray sensor from the light emitter, the heating controller detects the light that is generated by the light emitter and that is received by the infrared ray sensor to determine whether a stain is attached onto the top plate or not.

10. The induction heating device according to claim 9, further comprising
an object detector for detecting, based on the light received by the infrared ray sensor, whether or not the object is placed on the top plate,
wherein, when the object detector detects that the object is not placed on the top plate, the heating controller detects whether the stain is attached to the top plate or not.

11. The induction heating device according to claim 10, wherein the light emitter generates light when the object detector detects that the object is not placed on the top plate.

12. The induction heating device according to claim 1, further comprising an object detector for detecting, based on the light received by the infrared ray sensor, whether the object is placed on the top plate or not.

13. The induction heating device according to claim 1, further comprising:
a light emitter that generates light reaching the sensing element of the infrared ray sensor; and
a light blocker for selectively switching between a mode for preventing the light generated by the light emitter from reaching the sensing element of the infrared ray sensor from the light emitter and a mode for allowing the light generated by the light emitter to reach the sensing element of the infrared ray sensor from the light emitter.

14. The induction heating device according to claim 13, wherein, while the light blocker prevents the light generated by the light emitter from reaching the sensing element of the infrared ray sensor from the light emitter, the heating controller detects the light that is generated by the light emitter and that is received by the infrared ray sensor so as to detect whether a stain is attached onto the top plate or not.

15. The induction heating device according to claim 14, further comprising
an object detector for detecting, based on the light received by the infrared ray sensor, whether the object is placed on the top plate or not,
wherein, when the object detector detects that the object is not placed on the top plate, the heating controller detects whether the stain is attached onto the top plate or not.
